(19) United States
(12) Patent Application Publication
(10) Pub. No.: US 2022/0044312 A1
(43) Pub. Date: Feb. 10, 2022

(54) METHOD AND DEVICE FOR CONTROLLING A CRYPTOCURRENCY

(71) Applicant: Robert Bosch GmbH, Stuttgart (DE)

(72) Inventor: Alexander Poddey, Wiernsheim (DE)

(21) Appl. No.: 17/330,921

(22) Filed: May 26, 2021

(30) Foreign Application Priority Data
Aug. 6, 2020 (DE) 102020209999.5

(51) Int. Cl. G06Q 30/08; G06Q 20/06

(52) U.S. Cl. CPC G06Q 30/08; G06Q 20/065

(57) ABSTRACT

A method for controlling a cryptocurrency. The method includes: a bonding curve with desired properties is selected, a mechanical oscillation system is modeled in such a way that a bid price of the cryptocurrency corresponds to a first body and an ask price of the cryptocurrency corresponds to a second body of the oscillation system, the oscillation system is described with the aid of an equation of motion, and the bid price and the ask price are set according to the bonding curve and the equation of motion.

### CROSS REFERENCE

The present application claims the benefit under 35 U.S.C. § 119 of German Patent Application No. DE 102020209999.5 filed on Aug. 6, 2020, which is expressly incorporated herein by reference in its entirety.

### FIELD

The present invention relates to a method for controlling a cryptocurrency. The present invention also relates to a corresponding device, to a corresponding computer program, and to a corresponding machine-readable memory medium.

### BACKGROUND INFORMATION

Any protocol in computer networks, which brings about a consensus regarding the sequence of certain transactions, is referred to as a decentralized transaction system, a transaction database, or a distributed ledger. One frequent characteristic of such a system is based on a blockchain and forms the basis of numerous so-called cryptocurrencies.

Advanced cryptocurrencies make use of a mechanism known as “curved bonding”, according to which a function referred to as a bonding curve is defined algorithmically, which influences the price of tokens of the currency depending on the circulating assets thereof. The bonding curve is to this end implemented within the framework of a smart contract, which in particular defines the buy price at the time a token is minted and thus defines (in technical terms: “sets”) a bid price of the cryptocurrency.

A computer-implemented method for managing a cryptocurrency using “curved bonding” is described in PCT Patent Application No. WO 2019/043668 A1. To this end, an in-market wallet is made available to a large number of users, the wallet being suitable for storing linked digital tokens, which are linked to cryptocurrency tokens on a value basis and must be transacted on a digital marketplace platform.

A cryptocurrency reserve is provided for storing cryptocurrency tokens. When a user buys linked digital tokens in a marketplace transaction, the linked digital tokens are transferred to the marketplace wallet, and the corresponding value in the form of cryptocurrency tokens is transferred to the cryptocurrency reserve. In response to a user withdrawing a number of linked digital tokens from the in-market wallet, the desired number of linked digital tokens is removed from the user's in-market wallet and an equivalent value in the form of cryptocurrency tokens is transferred from the cryptocurrency reserve to a non-market wallet of the user for storing cryptocurrency tokens outside of the marketplace platform.

U.S. Patent Application Publication No. US 2020/0167512 A1 describes a framework for simulating the operation of a blockchain system. The simulation may produce quantitative, practical estimates as to how the variation of the bonding curve or other aspects of the system design affects performance, cost, and other metrics of interest. This is to enable designers and operators to use the data produced in one test or model in a different one, and to optimize the parameters or the protocol of the system in relation to one or multiple target functions.

U.S. Patent Application Publication No. US 2020/0104835 A1 describes a method for assisting transactions, which preferably provides an intermediary which maintains an order book and which is specified as the buyer on all orders in the order book. The method includes combining buy and sell orders into a single, inseparable batch order, adjusting the price in respect of the bid-ask spread, and transferring the profit from the spread to the second order in the order book.

A generalization of bonding curves, which is intended to make it easier to analyze the effects of adjustments of the function curve based on so-called configuration spaces, is described in ZARGHAM, Michael, SHORISH, Jamsheed; PARUCH, Krzysztof, “From Curved Bonding to Configuration Spaces,” 2019.

An alternative to “curved bonding” for reducing the volatility and stabilizing cryptocurrencies is discussed in SHIBANO, Kyohei, LIN, Ruxin; MOGI, Gento, “Volatility Reducing Effect by Introducing a Price Stabilization Agent on Cryptocurrencies Trading,” In: Proceedings of the 2020 The 2nd International Conference on Blockchain Technology. 2020. Pages 85-89.

Arbitrage and pricing in the cryptocurrency market are analyzed in MAKAROV, Igor, SCHOAR, Antoinette, “Trading and arbitrage in cryptocurrency markets,” Journal of Financial Economics, 2020, 135. Jg., No. 2, pages 293-319.

### SUMMARY

The present invention provides a method for controlling a cryptocurrency, a corresponding device, a corresponding computer program, and a corresponding machine-readable memory medium.

The approach according to the present invention is based on the finding that the size of a fair bid-ask spread changes over time. In this respect, the bid-ask spread should on the one hand be as small as possible since it causes additional costs for regular investors. On the other hand, it should be large enough to prevent moderate pump-and-dump or front-running attacks. In addition, a broad mounted pump-and-dump attack—in which the attacker causes a price push so that others buy due to the price movement in the hope of a further increase, whereupon the attacker promptly sells off his tokens—may not always be prevented by a spread that is fair for regular trading.

Based on these insights, an approach for automatically adjusting the bid-ask spread is provided, which is oriented toward the dynamics of the system and is based on a physical equation of motion. This approach enables the dynamics of the bid-ask spread to be parameterized on the basis of well-understood physical properties of dynamic systems. According to the provided approach in accordance with the present invention, the bid-ask spread is therefore selected dynamically, in one embodiment for example as a function of the volume of individual trading transactions.

Advantageous refinements, improvements, and example embodiments of the present invention are possible by virtue of the measures disclosed herein.

### BRIEF DESCRIPTION OF THE DRAWINGS

Exemplary embodiments of the present invention are shown in the figures and explained in greater detail in the following description.

FIG. 1 shows the flowchart of a method according to a first specific embodiment of the present invention.

FIG. 2 schematically shows a server according to a second specific embodiment of the present invention.

### DETAILED DESCRIPTION OF EXAMPLE EMBODIMENTS

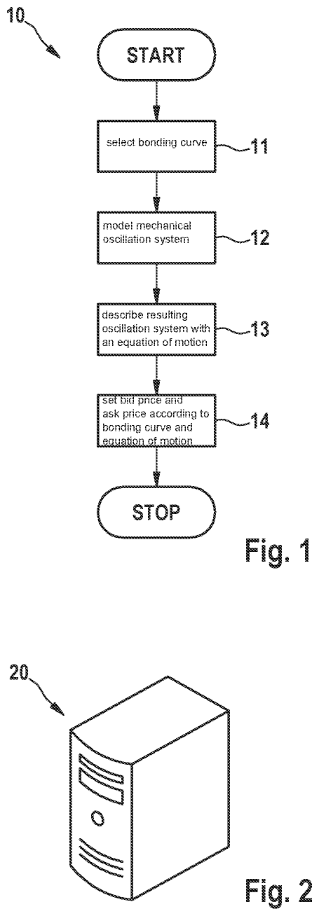

For the sake of simplicity, an approach in accordance with an example embodiment of the present invention will initially be explained on the basis of a single bonding curve with reference to FIG. 1. It may then easily be extended to the scenario of different buy and sell curves.

Initially, a bonding curve with desired properties—for example with regard to the volume of the currency reserve or further price support mechanisms—is selected (process 11).

A mechanical oscillation system, which is subject to attenuation and friction, is then modeled (process 12) in such a way that the bid price of the cryptocurrency corresponds to a first body and the ask price thereof corresponds to a second body of the oscillation system, the position of the mass-carrying bodies corresponding as it were to the “operating points” of the cryptocurrency with regard to the bid price and the ask price, while the distance therebetween is defined by the price difference.

The two bodies are connected here by one or multiple idealized or non-linear spring elements described by their zero-force length and spring constant.

In an alternative embodiment, the zero-force length of the spring may be assumed to be zero, while the spring connects the bodies via a rigid link of predefined length.

Effective friction (independent of speed), attenuation (proportional to speed) and higher-order loss terms may also be taken into account.

In addition to the inherent forces, the model may provide that a purchase of the cryptocurrency at the bid price exerts an impulse on the first body from the direction of the second body, while a sale of the cryptocurrency at the ask price conversely exerts an impulse on the second body from the direction of the first body. In this case, the magnitude of the respective impulse should correspond to the sell or buy volume, so as to increase the bid-ask spread temporarily.

The resulting oscillation system is described (process 13) with the aid of an equation of motion, the solution to which, together with the bonding curve, ultimately determines the bid price and ask price of the cryptocurrency and thus also the bid-ask spread thereof (process 14).

The parameters of such a differential equation, which is conventional to physicists, may be selected on the basis of physical analogies. For example, the effective zero-force length depends on the smallest possible bid-ask spread, which is selected for example in such a way that the bonding curve ensures fair earnings. The spring stiffness, attenuation and friction influence the average length of the spring at a given trading volume, as well as the “speed” of its convergence toward a smaller and in particular minimal length.

Alternatively, the modeling 12 may provide that—by bypassing the mechanical chain of action of the oscillation system—a purchase of the cryptocurrency at the bid price places the first body at a greater distance from the second body, and the sale of the cryptocurrency at the ask price places the second body at a greater distance from the first body. To illustrate this embodiment, the predefined bonding curve should initially be considered with the bid-ask spread: The conventional procedure in this scenario may be understood in such a way that the two operating points for buying and selling are coupled to one another by a rigid link.

In the event of a buy transaction, the new operating point on the buy side results from the increase in supply, while the price is determined by the integration of the bonding curve. The operating point on the sell side instantly follows this movement, in one simple approach according to the defined bid-ask spread. The procedure is the same for sell orders.

In the case of a dynamic procedure, the movement of the mass point on the buy side occurs immediately at the time of the buy order, while the sell side follows this movement only due to the force resulting from the spring connection. The sell side therefore does not react immediately, but rather according to the defined spring stiffness, attenuation and friction. This time-delayed reaction ensures that the bid-ask spread, which has suddenly increased following a buy order, is only slowly returned to the original size, in accordance with the defined system dynamics.

How the individual mass points move with respect to one another may be influenced by the mass ratio between the buy side and the sell side, which is provided during the modeling (12). If, for example, the mass on the buy side is much greater than that on the sell side, the sell side will predominantly follow the buy side. If, on the other hand, the masses are balanced, the two mass points will move equally with respect to one another.

If multiple buy orders of relatively large volume are transacted within a short period of time, the spread thus becomes increasingly large. Since the sell side does not follow the buy side immediately, but rather only gradually, pump-and-dump attacks become unprofitable for the attacker. In periods in which no new orders or only orders of relatively low volume are executed, the buy and sell sides move closer together again and the spread decreases. This procedure is applied analogously to sell orders, in which the mass point of the sell side is shifted.

Various possibilities exist regarding the continuation of the system behavior after the shift. In general, the shifted mass point has a certain speed before its position is changed due to the system dynamics. After the shift, this speed may be increased, adjusted or set to zero. All other parameters may also be adjusted or otherwise changed in a time-dependent manner. It may be possible, for example, adjusting the spring stiffness as a function of the trading volume within a certain period of time, which for example reduces the spring force at high volumes, reducing the zero-force length in phases of low trading volume, or using the total circulating amount of the cryptocurrency in place of the trading volume to adjust the parameters.

This method 10 may readily be generalized in such a way that the bid price and the ask price follow different bonding curves, without departing from the scope of the present invention.

The method 10 may for example be implemented in software or hardware or in a mixed form of software and hardware, for example in a server, as illustrated in the schematic diagram of FIG. 2.

What is claimed is:

1. A method for controlling a cryptocurrency, comprising the following steps:
selecting a bonding curve with desired properties;
modeling a mechanical oscillation system in such a way that a bid price of the cryptocurrency corresponds to a first body of the oscillation system and an ask price of the cryptocurrency corresponds to a second body of the oscillation system;
describing the oscillation system using an equation of motion; and
setting the bid price and the ask price are set according to the bonding curve and the equation of motion.

2. The method as recited in claim 1, wherein:
the oscillation system is modeled in such a way that a linear spring connects the first body to the second body, and
the equation of motion includes a predefined stiffness of the spring.

3. The method as recited in claim 2, wherein:
the oscillation system is modeled in such a way that the spring connects the bodies via a rigid link, and
the equation of motion includes a predefined length of the link.

4. The method as recited in claim 1, wherein:
the oscillation system is modelled taking attenuation into account, or
the oscillation system is modelled taking friction into account, or
the oscillation system is modelled taking higher-order losses into account.

5. The method as recited in claim 1, wherein:
the oscillation system is modeled in such a way that an impulse is exerted on the first body from a direction of the second body before or after a purchase of the cryptocurrency at the bid price, or
the oscillation system is modeled in such a way that an impulse is exerted on the second body from a direction of the first body before or after a sale of the cryptocurrency at the ask price.

6. The method as recited in claim 5, wherein:
the oscillation system is modelled in such a way that the impulse has a magnitude corresponding to a purchase or sale volume.

7. The method as recited in claim 1, wherein:
the oscillation system is modeled in such a way that the first body is placed at a greater distance from the second body before or after a purchase of the cryptocurrency at the bid price, or
the oscillation system is modeled in such a way that the second body is placed at a greater distance from the first body before or after a sale of the cryptocurrency at the ask price.

8. A non-transitory machine-readable memory medium on which is stored a computer program for controlling a cryptocurrency, the computer program, when executed by a computer, causing the computer to perform the following steps:
selecting a bonding curve with desired properties;
modeling a mechanical oscillation system in such a way that a bid price of the cryptocurrency corresponds to a first body of the oscillation system and an ask price of the cryptocurrency corresponds to a second body of the oscillation system;
describing the oscillation system using an equation of motion; and
setting the bid price and the ask price are set according to the bonding curve and the equation of motion.

9. A device configured to control a cryptocurrency, comprising the device configured to:
select a bonding curve with desired properties;
model a mechanical oscillation system in such a way that a bid price of the cryptocurrency corresponds to a first body of the oscillation system and an ask price of the cryptocurrency corresponds to a second body of the oscillation system;
describe the oscillation system using an equation of motion; and
set the bid price and the ask price are set according to the bonding curve and the equation of motion.
